(19) United States
(12) Patent Application Publication
(10) Pub. No.: US 2025/0185527 A1
(43) Pub. Date: Jun. 12, 2025

(54) Wrist-Worn Gardening Tool System

(71) Applicant: Karlyn Holt, Marion, IN (US)

(72) Inventor: Karlyn Holt, Marion, IN (US)

(21) Appl. No.: 18/537,498

(22) Filed: Dec. 12, 2023

(51) Int. Cl. A01B 1/06; A01B 1/20

(52) U.S. Cl. CPC A01B 1/06; A01B 1/20

(57) ABSTRACT

A wrist-worn gardening tool system for aerating soil for a household plant includes a band having an inner surface opposite an outer surface. The band can fit around a wrist of a user. The system further includes a gardening tool and a fastener releasably securing the gardening tool to the band. The gardening tool may include a soil manipulator that generally includes a body that can be gripped by a hand of the user. The body may be curved whereby the body is configured to complement a curvature of the wrist of the user. A plurality of tines is attached to and extends from an end of the body. The plurality of tines can be used to break up soil.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to gardening tools and more particularly pertains to a new gardening tool for aerating soil for a household plant.

### (2) Description of Related Art Including Information Disclosed Under 37 CFR 1.97 and 1.98

The prior art relates to gardening tools. The prior art discloses various gardening tools for aerating or otherwise manipulating soil, such as shovels, rakes, and trowels. The prior art also discloses assemblies for mounting or securing tools to a body of a user. For example, tool belts can releasably secure the tools to the waist. Such tools typically comprise blades or other cutting tools, hammers, wrenches, or screwdrivers. However, there is a need in the art for a body-worn device that can releasably secure a gardening tool to the body. There is also a need for a system that secures a soil manipulating tool that can be used to dig through and aerate soil for a household potted plant.

### BRIEF SUMMARY OF THE INVENTION

An embodiment of the disclosure meets the needs presented above by generally comprising a wrist-worn gardening tool system including a band having an inner surface opposite an outer surface. The band is configured to fit around a wrist of a user. The system further includes a gardening tool and a fastener releasably securing the gardening tool to the band.

There has thus been outlined, rather broadly, the more important features of the disclosure in order that the detailed description thereof that follows may be better understood, and in order that the present contribution to the art may be better appreciated. There are additional features of the disclosure that will be described hereinafter, and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a wrist-worn gardening tool system according to an embodiment of the disclosure.

FIG. 2 is an isometric view of an embodiment of the disclosure.

FIG. 3 is a cross-sectional view of an embodiment of the disclosure.

FIG. 4 is an isometric view of an embodiment of the disclosure.

FIG. 5 is a perspective view of an embodiment of the disclosure.

FIG. 6 is an isometric view of an embodiment of the disclosure.

FIG. 7 is an in-use view of an embodiment of the disclosure.

FIG. 8 is an in-use view of an embodiment of the disclosure.

FIG. 9 is a perspective view of an embodiment of the disclosure.

FIG. 10 is an in-use view of an embodiment of the disclosure.

FIG. 11 is an in-use view of an embodiment of the disclosure.

### DETAILED DESCRIPTION OF THE INVENTION

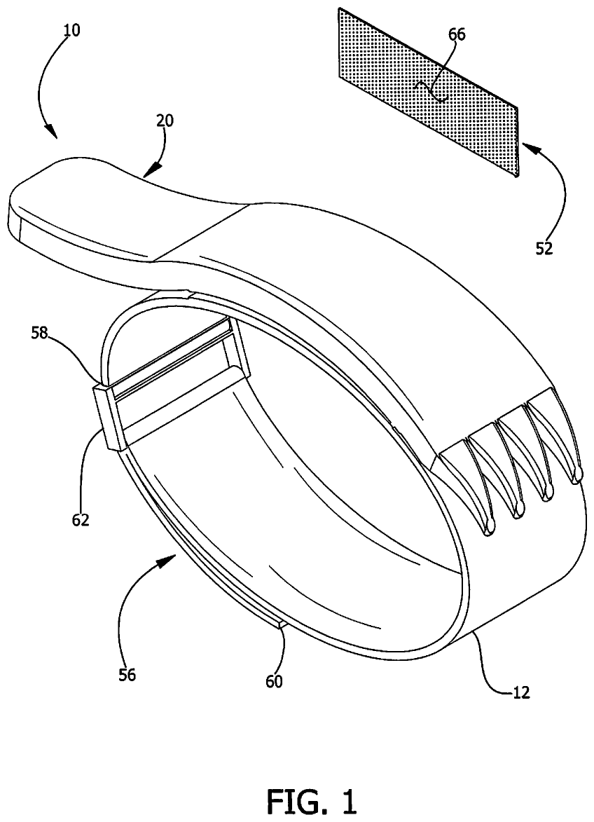

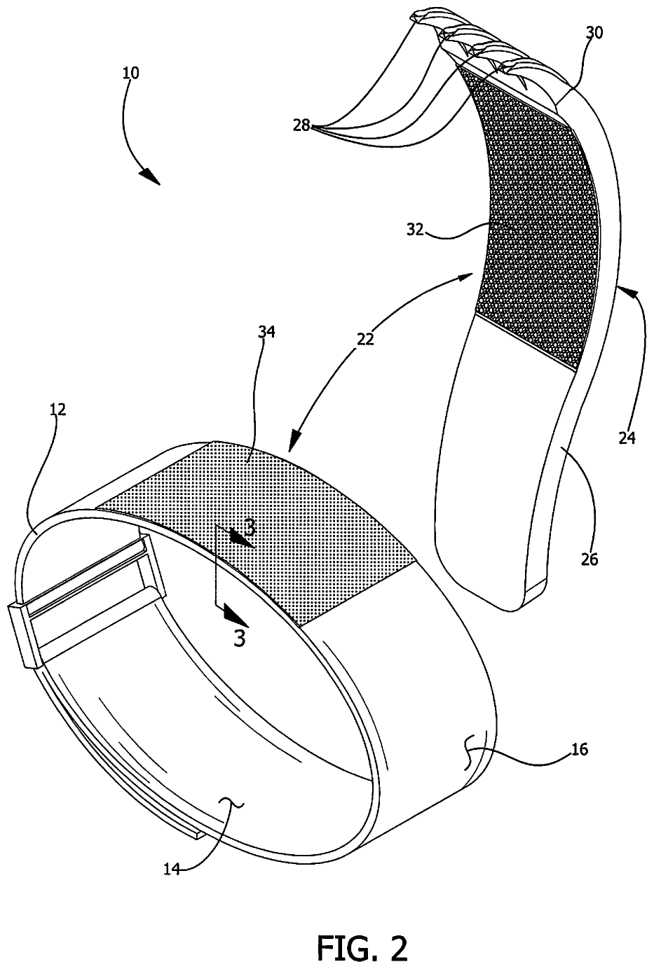

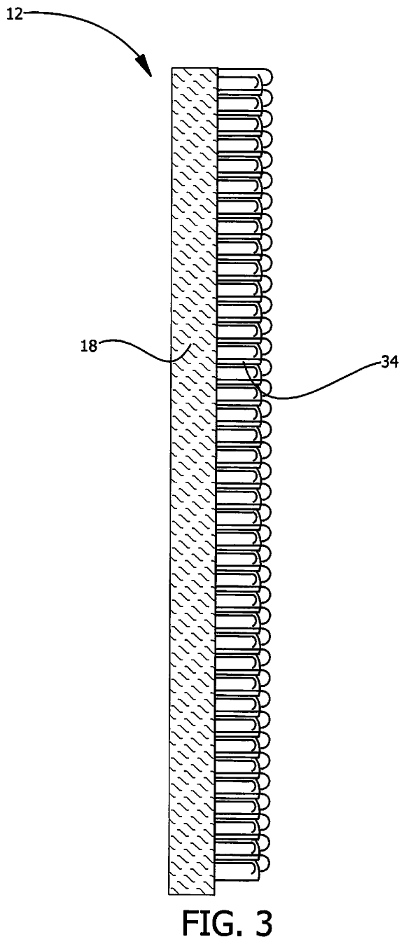

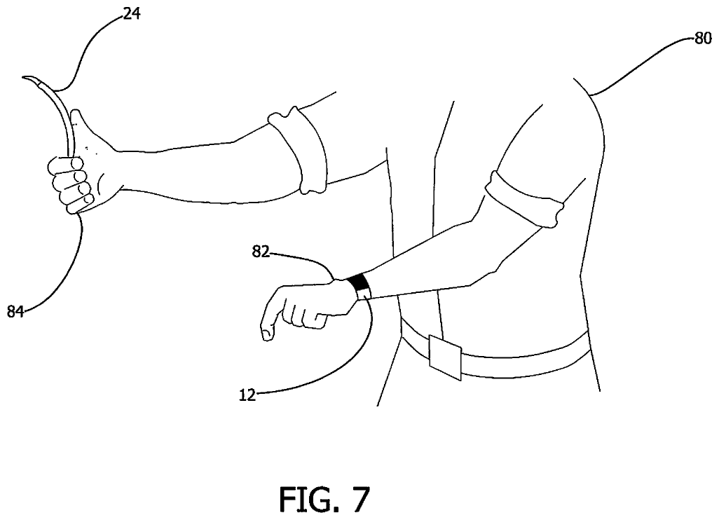

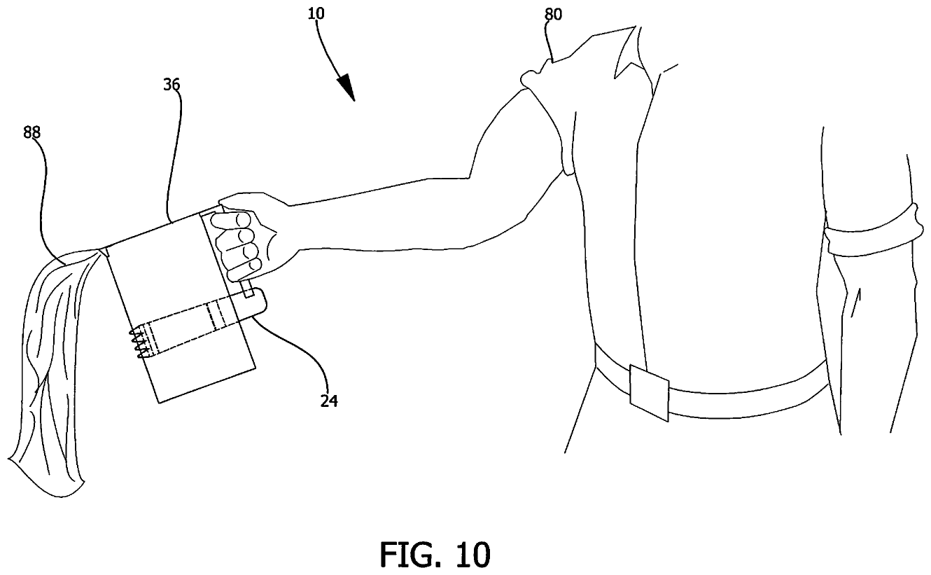

With reference now to the drawings, and in particular to FIGS. 1 through 11 thereof, a new gardening tool embodying the principles and concepts of an embodiment of the disclosure and generally designated by the reference numeral 10 will be described.

As best illustrated in FIGS. 1 through 11, the wrist-worn gardening tool system 10 generally comprises a band 12 having an inner surface 14 opposite an outer surface 16. The band 12 is configured to fit around a wrist 82 of a user 80. For example, the band may be placed on the wrist 82 of a non-dominant arm of the user 80. Thus, if the user 80 is right-handed, the user 80 may choose to fit the band 12 around the left wrist 82. Conversely, if the user 80 is left-handed, the user 80 may choose to fit the band 12 around the right wrist 82. In other examples, the band 12 may be positioned around the wrist 82 of the dominant arm of the user 80. The band 12 generally comprises a resiliently stretchable material 18. The wrist-worn gardening tool system 10 further comprises a gardening tool 20 and a fastener 22 releasably securing the gardening tool 20 to the band 12.

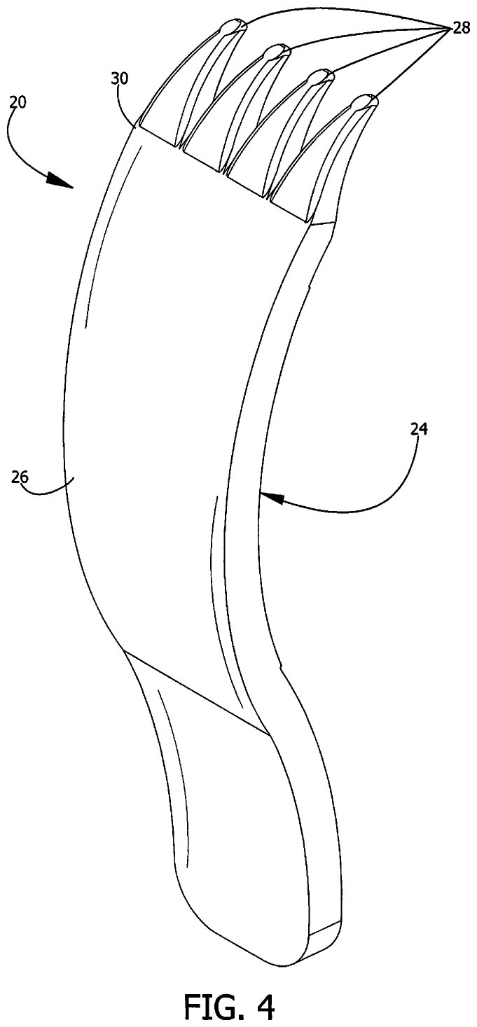

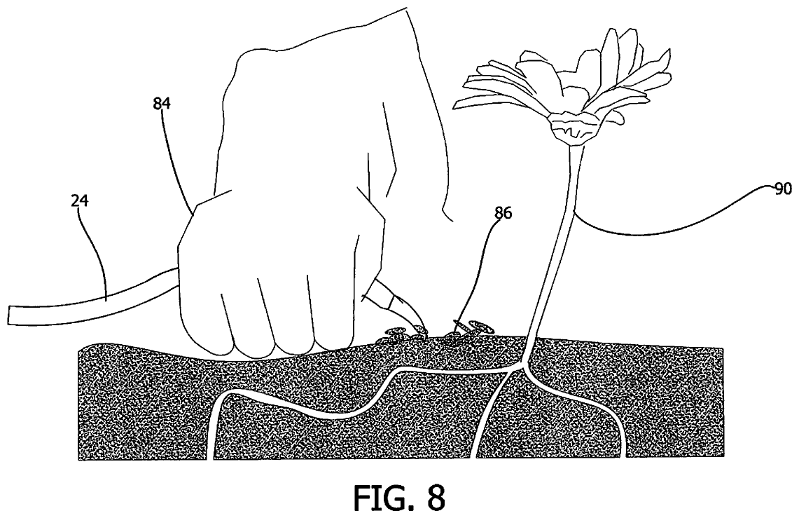

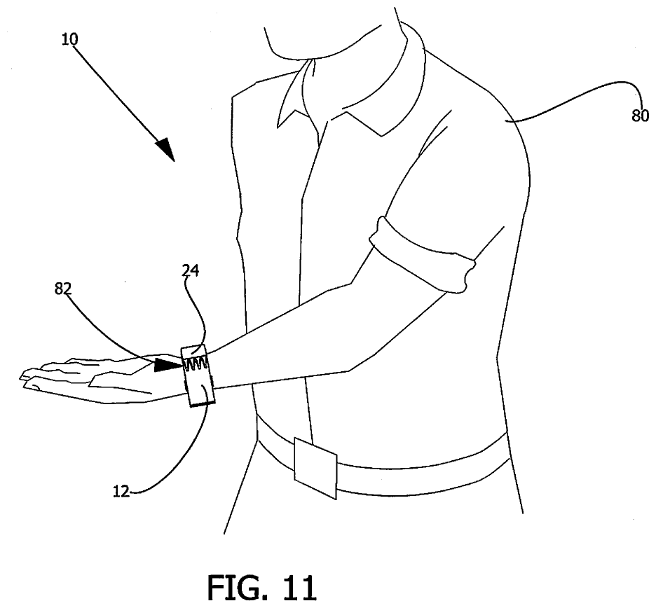

The gardening tool 20 may include a soil manipulator 24 that is configured to break up soil 86. The soil manipulator 24 generally comprises a body 26 that is configured for gripping by a hand 84 of the user 80. If the band 12 is positioned around the non-dominant wrist 82 as explained above, the soil manipulator 24 can be conveniently gripped by the dominant hand 84 of the user 80. In embodiments, the body 26 is curved whereby the body 26 is configured to complement a curvature of the wrist 82 of the user 80. Thus, the soil manipulator 24 can fit comfortably around the wrist 82 when the soil manipulator 24 is secured to the band 12 around the wrist 82, as shown in FIG. 11. A plurality of tines 28 may be attached to and extend from an end 30 of the body 26. The plurality of tines 28 are generally configured to break up soil 86. For example, as shown in FIG. 4, the plurality of tines 28 may be curved to further complement a curvature of the wrist 82 of the user 80. As shown in FIG. 8, the user 80 can grip the body 26 and use the plurality of tines 28 to break up the soil 86. For example, the user 80 may use the soil manipulator 24 to break up the soil 86 for a household potted plant 90, thereby aerating the soil 86 to improve the health of the plant 90. The soil manipulator 24 may also be used in alternative settings, such as gardens or planter boxes, where the user 80 wants to carefully manipulate the soil 86 in which the plant 90 is growing.

The fastener 22 may generally comprise a first mating member 32 that is attached to the gardening tool 20. A second mating member 34 is removably engageable with the first mating member 32. The band 12 has the second mating member 34 attached thereto. In the embodiments shown in the figures, the fastener 22 comprises a hook and loop material. However, alternative embodiments may use magnets or alternative fasteners to releasably secure the gardening tool 20 to the band 12.

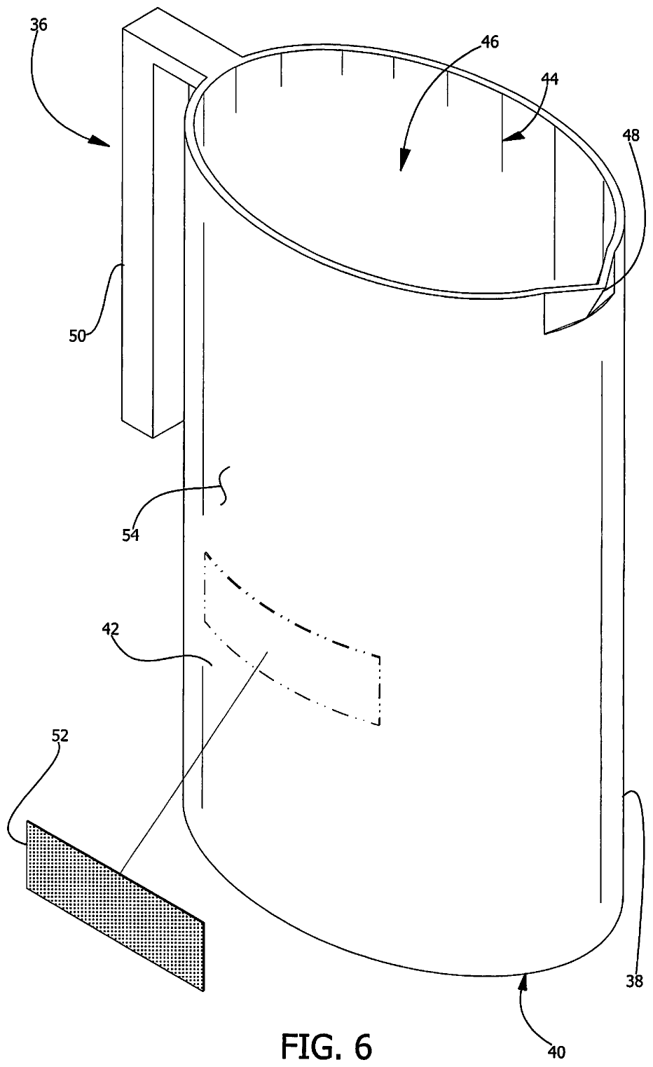

The gardening tool system 10 may further include a watering container 36 that is configured to hold and a liquid 88 and to direct a flow of the liquid 88 outwardly from the watering container 36. Any watering container 36 may be used, but FIGS. 6, 9, and 10 provide one embodiment. In that embodiment, the watering container 36 comprises a housing 38 having a bottom wall 40 and a perimeter wall 42 that is attached to and extends upwardly from the bottom wall 40. The perimeter wall 42 has an opening 44 therein to access an interior space 46 of the housing 38. The liquid 88 is held in the interior space 46. A spout 48 may be attached to the housing 38. The spout 48 is in fluid communication with the interior space 46. A handle 50 may be attached to and extend outwardly from the housing 38. An another one of the second mating members 52 can be attached to an outside surface 54 of the perimeter wall 42 for releasably coupling the gardening tool 20 to the watering container 36.

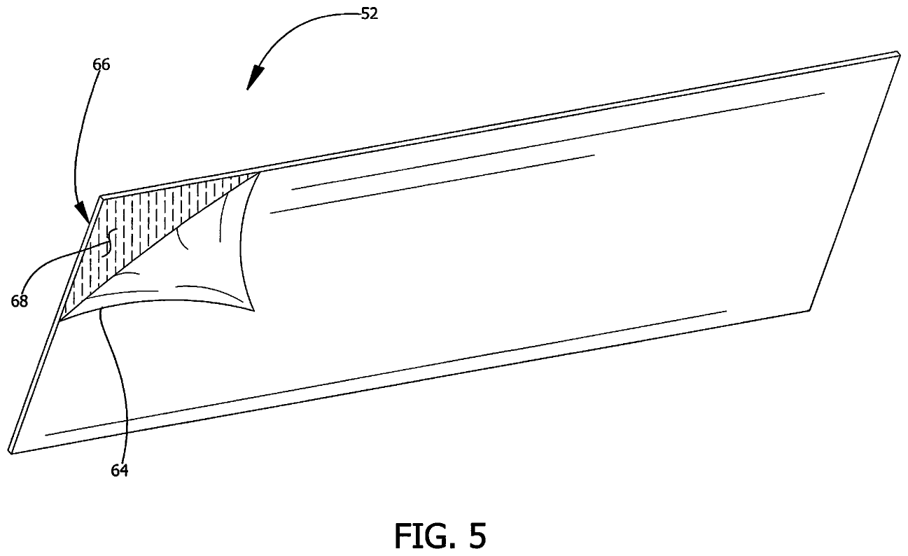

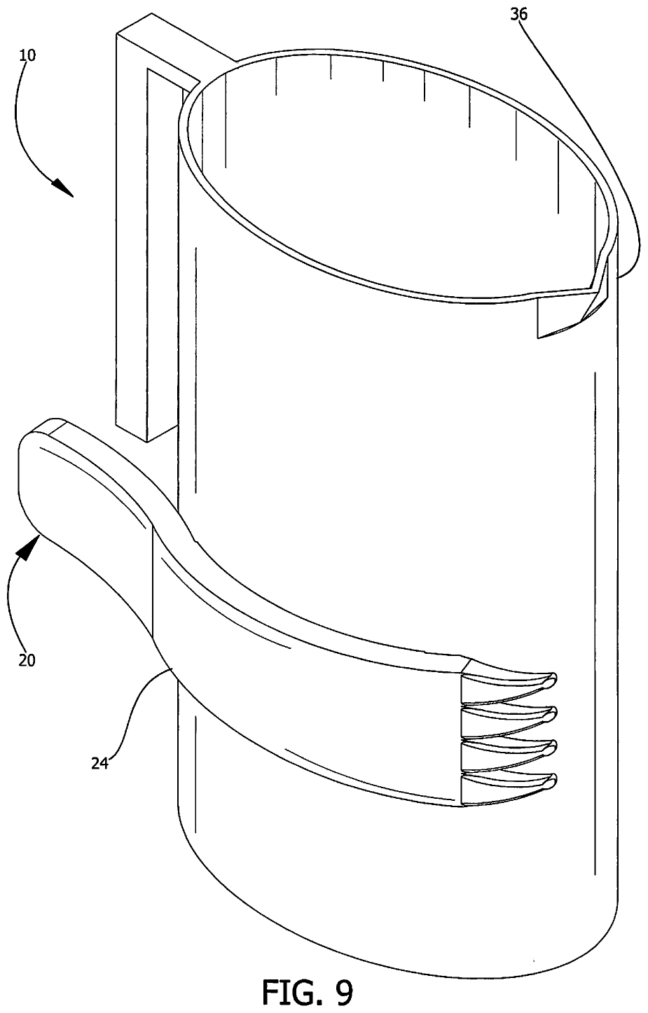

A cover 64 may be removably affixed to the another one of the second mating members 52. For example, the another one of the second mating members 52 may have a front side 66 opposite a back side 68. The front side 66 may generally include the fastener 22, such as the hook and loop material. The back side 68 may be adhesive and thereby configured to attach the another one of the second mating members 52 to the outside surface 54 of the perimeter wall 42 of the watering container 36. The adhesive back side 68 may be covered by the cover 64, as depicted in FIG. 5. The cover 64 may be generally configured to protect the adhesive back side 68 from being damaged before use. The cover 64 may also be easy to peel off of the adhesive back side 68 when the another one of the second mating members 52 is being used. As indicated in FIG. 6, once the cover 64 is removed, the adhesive back side 68 can be attached to the outside surface 54 of the watering container 36. As shown in FIG. 9, the gardening tool 20 can then be releasably coupled to the watering container 36.

The band 12 may also have a break 56 therein to define a first end 58 and a second end 60. The first end 58 may be couplable to the second end 60 whereby the band 12 forms a closed loop 56. A retainer 62 may be coupled to the band 12 that is configured to releasably retain the band 12 in the closed loop 56. In some embodiments, the retainer 62 is coupled to the first end 58. The second end 60 is adjustably coupled to the retainer 62 whereby a diameter of the closed loop 56 is adjustable. The closed loop is thereby configured to complement a diameter of the wrist 82 of the user 80. In other words, the size or circumference of the band 12 may be adjusted to fit a range of wrist sizes, similarly to an adjustable watch band.

In use, the user 80 can wear the band 12 and secure the gardening tool 20 to the band 12 to transport the gardening tool 20 to the plant 90. For example, if the user 80 has multiple houseplants, garden areas, or planter boxes, the user 80 may want to wear the gardening tool 20 on the band 12 while moving around to tend each plant 90. The user 80 can easily detach the gardening tool 20 from the band 12 to manipulate the soil 86 around each plant 90. For example, the user 80 can aerate the soil 86 by digging into the top surface of the soil 86 with the soil manipulator 24, as shown in FIG. 8. The user 80 can use the watering container 36 to water the plant 90. The user 80 can also store the gardening tool 20 on the watering container 36 using the another one of the second mating members 52. With this gardening tool system 10, the tools needed to care for each plant 90 can be readily available to the user 80.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A wrist-worn gardening tool system comprising:
a band having an inner surface opposite an outer surface, the band being configured to fit around a wrist of a user;
a gardening tool; and
a fastener releasably securing the gardening tool to the band.

2. The wrist-worn gardening tool system of claim 1, the band further comprising a resiliently stretchable material.

3. The wrist-worn gardening tool system of claim 1, wherein the band has a break therein to define a first end and a second end, the first end being couplable to the second end whereby the band forms a closed loop.

4. The wrist-worn gardening tool system of claim 3, further comprising a retainer being coupled to the band and being configured to releasably retain the band in the closed loop, the retainer being coupled to the first end, the second end being adjustably coupled to the retainer whereby a diameter of the closed loop is adjustable, the closed loop thereby being configured to complement a diameter of the wrist of the user.

5. The wrist-worn gardening tool system of claim 1, the gardening tool further comprising a soil manipulator being configured to break up soil.

6. The wrist-worn gardening tool system of claim 5, the soil manipulator further comprising:
a body being configured for gripping by a hand of the user, the body being curved whereby the body is configured to complement a curvature of the wrist of the user; and
a plurality of tines being attached to and extending from an end of the body, the plurality of tines being configured to break up the soil.

7. The wrist-worn gardening tool system of claim 1, wherein the fastener comprises a hook and loop material.

8. The wrist-worn gardening tool system of claim 1, the fastener further comprising:
a first mating member being attached to the gardening tool; and
a second mating member being removably engageable with the first mating member, the band having the second mating member attached thereto.

9. The wrist-worn gardening tool system of claim 8, further comprising:
a watering container being configured to hold and a liquid and direct a flow of the liquid outwardly from the watering container, the watering container including:
a housing having a bottom wall and a perimeter wall being attached to and extending upwardly from the bottom wall, the perimeter wall having an opening therein to access an interior space of the housing, the liquid being held in the interior space;
a spout being attached to the housing and being in fluid communication with the interior space;
a handle being attached to and extending outwardly from the housing; and
an another one of the second mating members being attached to an outside surface of the perimeter wall for releasably coupling the gardening tool to the watering container.

10. A wrist-worn gardening tool system comprising:
a band having an inner surface opposite an outer surface, the band being configured to fit around a wrist of a user, the band comprising a resiliently stretchable material;
a gardening tool;
a fastener releasably securing the gardening tool to the band;
the gardening tool including a soil manipulator being configured to break up soil, the soil manipulator comprising:
a body being configured for gripping by a hand of the user, the body being curved whereby the body is configured to complement a curvature of the wrist of the user;
a plurality of tines being attached to and extending from an end of the body, the plurality of tines being configured to break up the soil;
the fastener comprising:
a first mating member being attached to the gardening tool;
a second mating member being removably engageable with the first mating member, the band having the second mating member attached thereto;
wherein the fastener comprises a hook and loop material;
a watering container being configured to hold and a liquid and direct a flow of the liquid outwardly from the watering container, the watering container comprising:
a housing having a bottom wall and a perimeter wall being attached to and extending upwardly from the bottom wall, the perimeter wall having an opening therein to access an interior space of the housing, the liquid being held in the interior space;
a spout being attached to the housing and being in fluid communication with the interior space;
a handle being attached to and extending outwardly from the housing; and
an another one of the second mating members being attached to an outside surface of the perimeter wall for releasably coupling the gardening tool to the watering container.
